(19) United States
(12) Patent Application Publication
(10) Pub. No.: US 2024/0188757 A1
(43) Pub. Date: Jun. 13, 2024

(54) SMART COOKING APPLIANCE

(71) Applicant: June Life, LLC, San Francisco, CA (US)

(72) Inventors: Nikhil Bhogal, San Francisco, CA (US); Gabriel Risk, San Francisco, CA (US); Nicholas Beyrer, San Francisco, CA (US)

(21) Appl. No.: 18/080,618

(22) Filed: Dec. 13, 2022

(51) Int. Cl. A47J 37/07; A47J 36/32

(52) U.S. Cl. CPC A47J 37/0786; A47J 36/321

(57) ABSTRACT

In variants, the system can include an extensible cooking system (e.g., grill) with a removable user interface configured to control cooking system operation and/or a set of removable accessory modules. Examples of removable accessory modules can include user fuel control interfaces and sensor ports.

### TECHNICAL FIELD

This invention relates generally to the food preparation field, and more specifically to a new and useful cooking appliance in the food preparation field.

### BRIEF DESCRIPTION OF THE FIGURES

FIG. 1 is an example of the system in use.

FIG. 2A is an example embodiment of the system.

FIG. 2B depicts example embodiments of components of the system.

FIG. 3 is a schematic diagram of an embodiment of the system.

FIG. 4 is a schematic diagram of an embodiment of the system.

FIG. 5 is a schematic diagram of an example operation mode.

FIGS. 6A and 6B are schematic diagrams of a first and second variant of a second example operation mode.

FIGS. 7A and 7B are an example embodiment of a user interface controller and UIC connect mount on a grill body.

FIG. 8A is an example embodiment of a user interface controller and a compatible power and data cable.

FIG. 8B is an example embodiment of a user interface controller mounted to a stand.

FIG. 9 depicts multiple example embodiments of user interface controllers.

FIG. 10 is an example embodiment of a user interface controller connected to an accessory module.

FIG. 11A is a schematic diagram of components involved in a 2-step ignition sequence.

FIG. 11B is a schematic example of a process for a 2-step ignition sequence.

FIGS. 12A, 12B and 12C are schematic example embodiments of processes for a 2-step ignition sequence.

FIGS. 13A and 13B are schematic examples of accessory modules.

FIGS. 14A, 14B, and 14C are alternative views of an example embodiment of a probe hub.

FIG. 15 is a schematic representation of an example of an accessory module.

FIG. 16 is a schematic representation of an example of the system.

### DETAILED DESCRIPTION

The following description of the embodiments of the invention is not intended to limit the invention to these embodiments, but rather to enable any person skilled in the art to make and use this invention.

### 1. Smart Grill 100

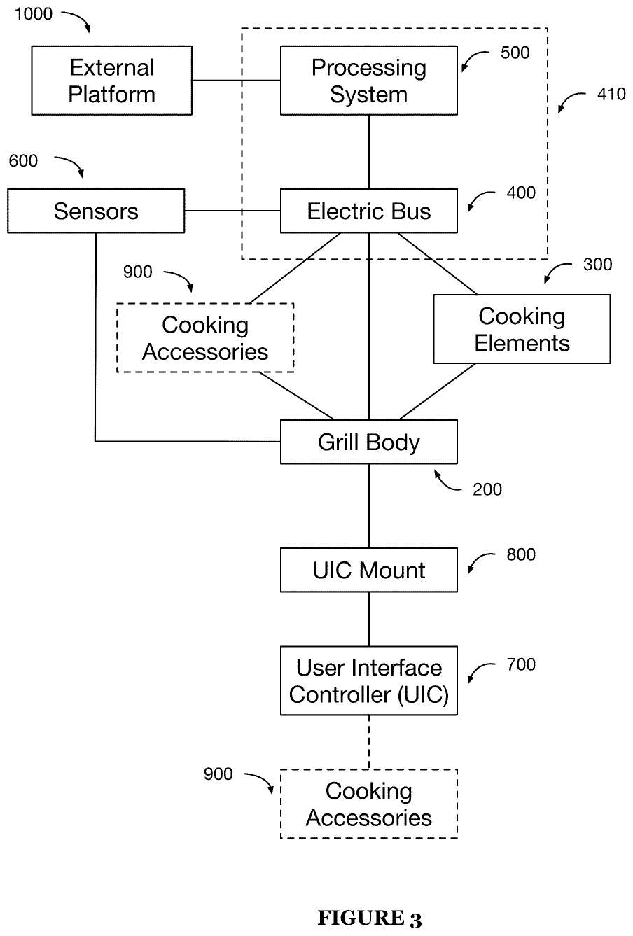

As shown in FIG. 3, an embodiment of a smart grill 100 can include: a grill body 200, a set of cooking elements 300, a set of sensors 600, a user interface controller 700, an optional set of accessory modules 900, a control system 410 including a processing system 500, and/or other components. The grill can additionally or alternatively be used with one or more external platforms 1000, a mobile device application, and/or any other suitable elements.

### 2. Technical Advantages

The smart grill 100 can confer several benefits over conventional grills. First, the smart grill can decrease the costs associated with upgrading an individual grilling system. Traditionally, if a grill owner wants to increase their grill's capabilities, they need to purchase an entirely new grilling system. Existing smart grills feature large quantities of expensive electrical components, driving up the cost as compared to traditional grills. In variants, the smart grill is designed to allow a user to upgrade their grill and expand its capabilities by replacing the user interface controller, by replacing or adding accessories, and/or by downloading software updates.

Second, the smart grill can be built on a common system platform that is extensible using a platform-standard set of connectors and communication protocols. This can enable multiple grill models to be rapidly developed using the same system platform (e.g., by connecting different grill bodies, different combinations of accessories, different heating elements, etc. to the same platform), instead of fully redesigning each grill model. This can also enable centralized management of the system (e.g., centralized software updates), and can also enable new accessories to work with any smart grill built on the common platform (e.g., enable forward and/or backward compatibility). In variants, the accessories can each include an onboard processing system that translates data from accessory module-specific protocols into platform-standard protocols, which allows the common system platform to be compatible with a wide variety of accessories without reprogramming each control system. In an example, a manufacturer can guarantee a long-term warranty on their smart grills without needing to stockpile components, as new components will still be compatible with older versions of the system.

Third, the smart grill can facilitate cooking in methods beyond grilling, all from one appliance. For example, in embodiments the system can support smoking, baking, frying, or any other suitable cooking method by dynamically mapping a physical input from a user on a physical interface of the grill (e.g., a button or a knob) to an output specific to the current cooking mode or recipe.

Fourth, the smart grill can perform “hands-free cooking”. For example, the grill can automatically identify and/or characterize the food placed within the cooking cavity, automatically determine a recipe based on the food identity and/or characteristics, and automatically control grill operation according to the recipe. In variants, the grill can prompt the user to interact with the food item at points throughout the cooking process, or can fully operate with as little interaction from a user as receiving a food item from said user.

In an illustrative example, the smart grill can include an onboard control system and a removable user interface controller. In variants, the user interface controller can include a touchscreen display, a knob, wireless connectivity, and/or other components, can function as the intermediary between the grill and the cloud platform, and/or can execute processes that require higher computational power (e.g., food identification, cooking state tracking, wireless device pairing, etc.). In variants, the smart grill can also include a set of input/output modules (e.g., buttons, displays, sensors, sensor hubs, etc.) that are connectable to the control system via a standardized interface. In variants, each input/output module can include a module controller (e.g., microprocessor) configured to translate between a grill-standard protocol and an input/output standard-protocol (e.g., accessory protocol).

### 3. System

As shown in FIG. 3, an embodiment of a smart grill 100 can include: a grill body 200, a set of cooking elements 300, a set of sensors 600, a user interface controller 700, a set of accessory modules 900, a control system 410, and/or other components. The smart grill can additionally or alternatively be used with one or more external platforms 1000, a mobile device application, and/or any other suitable elements.

Discussions and descriptions of grills herein can be equally applied to other cooking appliances, such as ovens, stovetops, burners, and/or other cooking appliances.

The smart grill can function to automate all or portions of the cooking process.

The smart grill can be any type of grill (including gas grills, charcoal grills, electric grills, pellet grills, wood grills, kettle grills, kamado grills, etc.), any category of smoker (e.g., offset smoker, pellet smoker, electric smoker), any combination thereof, and/or be any other suitable grill.

The smart grill can enable one or more cooking types or modes, including one or more of: grilling, smoking, microwaving, frying, boiling, baking, searing, broiling, etc.

### Grill Body 200

The grill body 200 can function to house and/or retain all or a portion of the other system components, define a cook cavity, retain food while cooking, and/or perform any other suitable function.

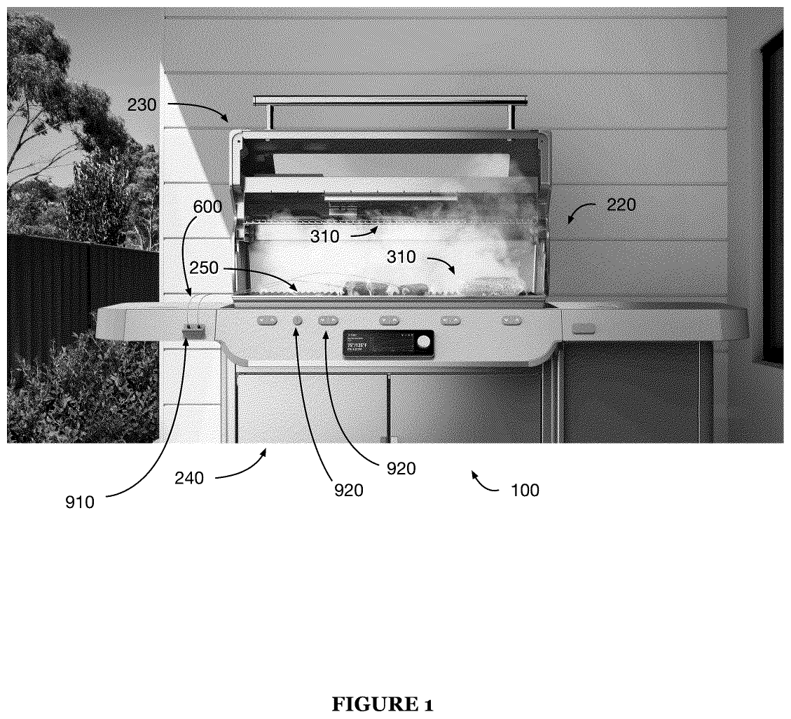

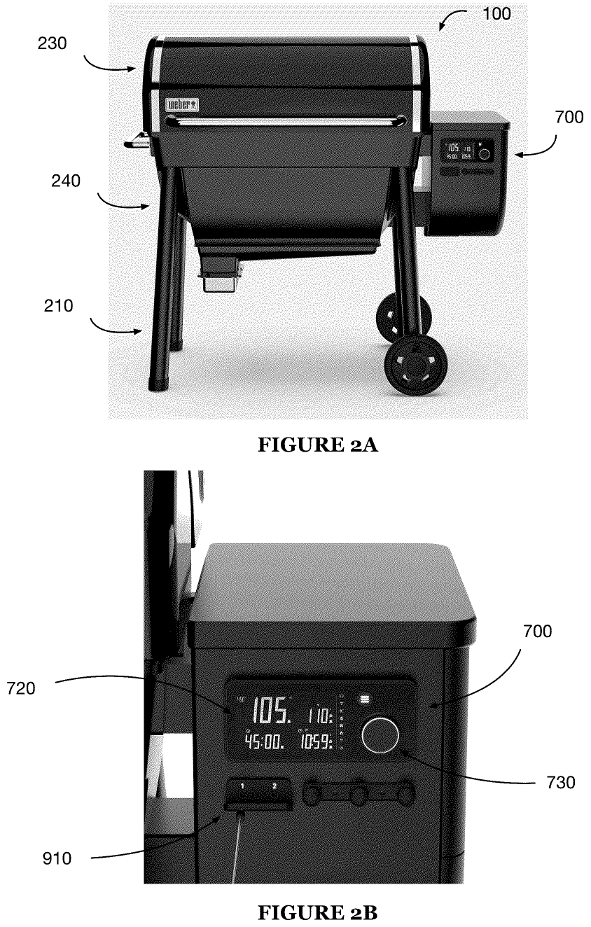

The grill body 200 can include: a grill base 240, a lid 230, a support structure 210, and/or other components (e.g., examples shown in FIG. 1 and FIG. 2A). The grill body is preferably rigid, but can alternatively be flexible. The grill base is preferably hollow, but can alternatively be solid, be subdivided into individual cavities (e.g., fluidly isolated cavities), and/or be otherwise constructed. The lid can, be hinged (e.g., along the back, along the side, along the back, etc.), and/or be otherwise attached to the grill base. The lid can be mounted to the top of the grill body (e.g., the top back edge opposite the user-facing side) by a hinge, be mounted at other locations (e.g., (e.g., along the side, along the front, etc.), slide relative to the grill base, be fully removable from the grill base, and/or be otherwise connected to the grill base (e.g., a sliding mechanism, groove joint, etc.). Other components can be attached to the lid (e.g., displays, a cooling rack, etc.). The support structure can include legs, a pedestal, wheels, and/or any other suitable support structure. The support structure and/or grill base may further serve to conceal other components (e.g., a propane tank, electronic components, etc.) from view and/or from natural elements (e.g., water). The grill body 200 can additionally or alternatively include tables, side burners, and/or other components.

The grill body can house components of the control system 410 in an interior cavity (e.g., a sheet metal cabinet below the cook chamber). Walls of this interior cavity can function to shield the processing system, bus, and cable elements from water and other elements. Alternatively, the interior cavity can include openings for water ingress and/or egress.

The grill body can be configured to mount and/or connect to other components. The grill body may include a user-facing side, front side, back side, top, bottom, right, left, and/or other sides. Displays, user interface controllers, user input devices, accessory modules and/or any other suitable elements may be attached to any side of the grill. The component can be mounted to an opening defined in the grill body, connected to a connector accessible via the grill body, and/or otherwise connected to the grill body. The grill can be used with a set of waterproofing covers 930, that can be plugged into, mounted over, or otherwise shield the openings and/or an electrical connectors from the elements when an accessory module is not plugged into the opening and/or connector.

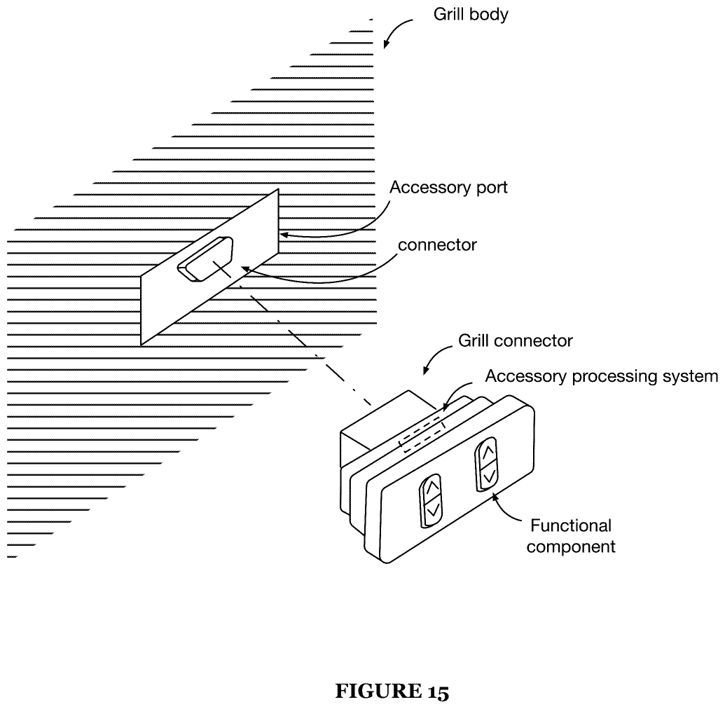

As shown in FIG. 15, the grill body can include a set of accessory module ports. The accessory module ports are preferably openings or blanks in the grill body configured to accept an accessory module, but can additionally or alternatively include retention mechanisms (e.g., clips, springs, screw holes, etc.), keying features, and/or other features. The accessory module ports can be located: in the front of the grill body (e.g., the front of the grill base), the side of the grill body, the top of the grill body (e.g., on the lid), the back of the grill body (e.g., the back of the cooking cavity), the side of the grill body, interior of the grill body (e.g., along the cooking cavity wall), the exterior of the grill body, grill base interior, grill base exterior, lid interior (ex. front edge, back edge, top center, top side), lid exterior, and/or be otherwise located. Electrical connectors for the accessory modules can be accessed through the accessory module ports, or otherwise accessed.

The grill body can include one or more complimentary connect mounts 850, which function to connect the UIC to the grill body. The complimentary connect mount 850 is preferably complimentary to the UIC connect mount 800, but can be otherwise configured. The complimentary connect mount preferably removably connects the UIC to the grill body, but can alternatively permanently connect the UIC to the grill body. A complimentary connect mount 850 can include: a retention mechanism 870, an electrical connection 890, and/or other components.

The retention mechanism 870 preferably removably retains the UIC, but can alternatively permanently retain the UIC. The retention mechanism is preferably an opening in the grill body, wherein the UIC includes a complimentary component that slots into the opening (e.g., the protrusion or shield 830), but can alternatively be a protrusion that slots into the UIC, a stand, a magnet, Velcro, and/or include another retention mechanism. The opening is preferably a recess, but can alternatively be a through hole or other opening. The retention mechanism can additionally or alternatively include secondary retention mechanisms along the boundary of the opening, such as clips, springs, screw holes, and/or other retention mechanisms that function to retain the UIC. The retention mechanism can additionally or alternatively include alignment features (e.g., along the opening boundary), such as protrusions or fins, recesses, and/or other features. The alignment features can be symmetric or asymmetric.

The electrical connection 890 functions to connect to the UIC connector 820. The electrical connection 890 is preferably accessible through the retention mechanism (e.g., through the opening), but can alternatively be accessible from the side of the retention mechanism and/or otherwise arranged relative to the retention mechanism. The electrical connection is preferably centered in the retention mechanism, but can alternatively be offset, located outside of the retention mechanism, and/or otherwise located. In examples, the electrical connection is arranged along the middle of the retention mechanism's opening. The electrical connection preferably includes an extendable cord (e.g., with or without a cord retraction mechanism) that plugs into the UIC, but can alternatively be a statically mounted connector (e.g., wherein the UIC plugs into the static connector), be a wireless connection (e.g., NFC, RF, induction, and/or other mechanisms), and/or any other suitable electrical connection. The electrical connection is preferably a power and data connection, but can alternatively be power-only or data-only. The electrical connection preferably includes a standard connector (e.g., USB, USB-A, USB-C, micro-USB, lightning, thunderbolt, etc.), but can alternatively be a proprietary connector.

In an illustrative example, the complimentary connect mount can include a recess in an exterior surface of the cooking body and a cable located within the recess.

However, the complimentary connect mount can be otherwise configured.

The grill body 200 can define a cook cavity 220. The cook cavity 220 can be defined by the grill base, be cooperatively defined by a lid 230 and a grill base 240, and/or be otherwise defined. The cook cavity can be configured to receive and retain food during cooking. For example, the cook cavity can include a grate 250, a rack, a rotisserie spit, an exhaust pipe, a wok, a pizza pan, or other food retention mechanism located inside the cook cavity. The parameters of the food retention mechanism (e.g., height, position, rotation rate, etc.) can be manually determined, manually controlled, automatically determined (e.g., based on a recipe), automatically controlled (e.g., by the control system, by the UIC, etc.), and/or otherwise determined and/or controlled. Grill operation parameters can be determined based on the identity and/or parameters of the food retention mechanism, or be otherwise determined. For example, a recipe may include specialized heat profiles to support cooking a pizza on a pizza pan as opposed to a grate.

Optionally, the food retention mechanism can include one or more identifiers. The food retention mechanism identifiers can be printed, embossed, stamped, embedded, and/or otherwise located on the food retention mechanism. Examples of food retention identifiers can include: visual identifiers (e.g., QR codes, barcodes, alphanumeric identifiers, etc.); wireless identifiers (e.g., NFC identifiers, etc.); and/or other identifiers. Grate identifiers can be semantic or non-semantic. Grate identifiers can be used to determine and/or verify food position within the grill, determine grate parameters (e.g., grate position, grate height, etc.), associate cooking parameters and/or with the grate parameters, uniquely identify the grill, uniquely identify the grate, identify attributes of the grate, function as a calibration target (e.g., when the identifier has known dimensions), function as an orientation identifier (e.g., wherein the identifier is located in a known position), and/or otherwise used.

Food can be cooked inside the cook cavity, and/or another location (e.g., on a burner next to the cook cavity).

The grill body can further include components that function to cook, cool, and/or otherwise aid food preparation outside of the grill cavity. An external burner may optionally enable expanded styles of cooking (e.g., stir frying, boiling, etc.). An external cooling tray and/or other tray may optionally be attached to the grill body exterior. The grill body exterior may feature a side table (e.g., for food preparation, for placing cooking utensils, etc.).

### Cooking Elements 300

The smart grill 100 can include or be used with a set of cooking elements 300, which can function to direct heat within the grill system. Cooking elements may be situated in the interior of the cook cavity and/or outside of grill cavity. Cooking elements can be located along the cook cavity: bottom, top, sides (e.g., front, back, left, right, etc.), and/or any other suitable position on the grill body. Cooking elements can be attached to the grill lid.

Cooking elements can be individually controllable or controllable in sets. The cooking elements can be automatically controlled (e.g., by the grill processing system, the UIC, a smartphone, smartphone application, a cloud platform, etc.), manually controlled, uncontrolled, and/or otherwise controlled. In a first example, the cooking elements can be controlled by a dedicated user input (e.g., set of buttons). In a second example, the cooking elements can be controlled by the UIC (e.g., wherein the cooking elements to control is selected on the UIC interface). Each cooking element can be controlled by one or more user inputs. A command to modify the state of a cooking element can be initiated by a set of operation instructions (e.g., a recipe), an input at a user input device (e.g., a smart button), an input at the user interface controller input (e.g., touchscreen selection, knob selection, etc.), and/or any other suitable instruction. In examples, the cooking elements can be controlled by a dedicated cooking element controller, wherein the cooking element controller is controlled by the grill processing system; however, the cooking element controller can be otherwise controlled. Parameters of the cooking elements that can be controlled can include: the amount of heat output, the fuel flow rate (e.g., gas flow rate, pellet flow rate, auger rotation rate, etc.), the air flow rate, and/or any other suitable cooking element parameter. The cooking elements can be controlled based on a target cooking element parameter value (e.g., selected by the input), target cooking cavity state (e.g., target cooking cavity temperature), and/or based on any other suitable target parameter.

Cooking elements may include heating elements 310, circulation elements 320, ignition elements 330, and/or any other suitable elements.

Heating elements 310 can be: open flames, hot rods, gas burners, electric burners, broiler elements, infrared sear burners, smoke, burn pot, resistance wires, thick film heaters, composite heating elements, and/or any other suitable element. Fuel sources can be: electricity, gas (e.g., natural, propane, etc.), wood, charcoal, pellet, and/or any other source and/or some combination thereof. The heating elements can cook food through convection, conduction, radiation, or any combination thereof.

Heating elements 310 can be individually controllable or controllable in sets (e.g., wherein a set of heating elements cooperatively define a zone). In variants, a grill can include or be used with multiple heating elements of the same type (e.g., gas burners, flames, etc.) to enable control of a heat profile. In further variants, a grill can include multiple heating elements to achieve different styles of cooking (e.g., pellets and a sear burner).

In one example, primary heating elements can be located inside of the grill cavity, situated below the grate. In another example, additional heating elements can be located at other parts of the grill to facilitate cooking functionality (e.g., side burner adjacent to the cook cavity, IR burner built into the lid, etc.).

Ignition elements 330 can be: a pellet igniter, a combustion igniter, a spark igniter, electronic igniters, and/or any other suitable form of igniter. Ignition elements 330 can be located proximally to a heating element and/or a line leading to a heating element, and/or otherwise positioned to light the heating element. The ignition input interfaces can be located on the grill, proximal the grill, remote from the grill, and/or otherwise positioned relative to the grill. The ignition of a heating element is preferably triggered by a multi-step ignition process (e.g., 2-step ignition process), but can additionally or alternatively be triggered by a 1-step ignition process, and/or any other ignition process.

Optional circulation elements 320 can be: fans, exhaust pipes, vents, valves, and/or any other suitable element. They can be passive, or actively controlled (e.g., by the processing system).

However, the smart grill can include any other suitable set of cooking elements.

### User Interface Controller 700

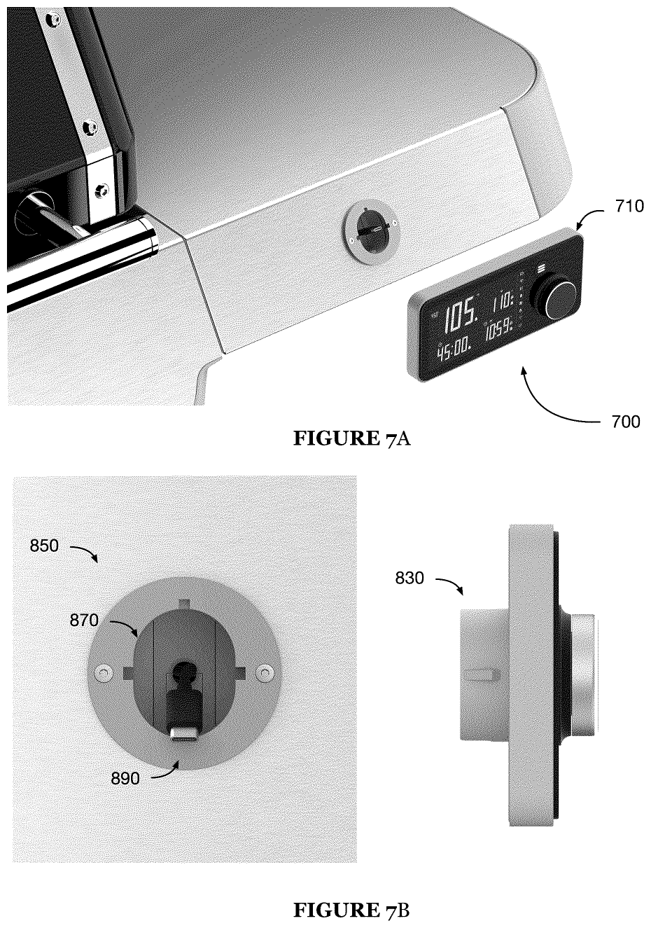

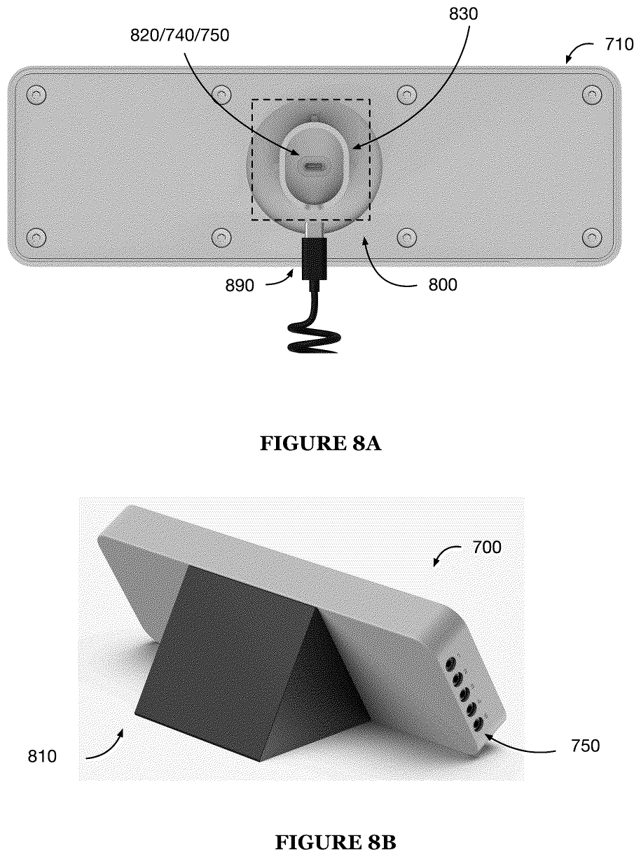

A smart grill can be used with and/or include one or more UICs (e.g., wherein one can be swapped out for another, wherein multiple UICs can be used simultaneously, etc.). As shown in FIGS. 7A, 7B and 8A, the user interface controller (UIC) 700 of the smart grill can function to control the smart grill, function as an input for the smart grill, function to present information relevant to the cooking session to a user, function as an intermediary between the user, an external database, the processing system 500, function as a gateway for the smart grill (e.g., provide wireless connectivity for the grill), and/or perform any other suitable set of functionalities.

In an embodiment, the UIC can communicate directly with the processing system 500 through a cabled connection, a wireless connection, and/or both. The UIC can access an external platform 1000 (e.g., cloud structure, database, the June cloud, etc.) that stores recipes and send session history to the external platform. The UIC can optionally communicate with other endpoints (e.g., a website, a mobile device application, etc.) wirelessly and/or over a wired connection. The UIC can be used to sign into an account (e.g., June oven profile, Weber profile, Alexa/Amazon, Google, etc.). In variants, the UIC can be configured to interact with other devices (e.g., a June oven) wirelessly (e.g., through a mobile application, over a server, etc.).

The UIC can drive the user's interaction with the grill. In variants, the UIC can determine a cook program for the food, guide the user through a cook program (e.g., instruct user to move the food when a target internal temperature is reached), interpret grill inputs (e.g., map grill inputs to grill outputs, such as based on the current recipe), determine grill outputs, control grill outputs (e.g., via the processing system 500), set the grill input mappings (e.g., used by the processing system 500), and/or otherwise enable user interaction with the grill.

The UIC device can interact with one or more cooking appliances. For example, a single UIC device can be used with multiple smart devices (e.g., multiple grills, heterogeneous cooking appliances, etc.). In an illustrative example, a single UIC device that stores a user's profile and preferences can be plugged into a first smart device (e.g., a smart grill, a smart oven, etc.) to execute a first cooking session, and later plugged into a second smart device (e.g., a smart oven, a smart grill, etc.) to execute a second cooking session. Information collected during the first cooking session can be used to determine operation instructions for the second cooking session. Information collected during the first cooking session can be displayed and/or downloaded onto the second smart device. Further cooking sessions on the same smart devices and/or further smart devices can be executed with the same UIC device.

In another example, a single UIC can be used to operate two or more smart grills simultaneously (e.g., wherein the UIC is plugged into a first smart grill and simultaneously remotely connected to a second smart grill, wherein the UIC is remotely connected to two smart grills).

The UIC is preferably removably connected to the grill body, but can alternatively be permanently mounted to the grill body, be permanently mounted elsewhere (e.g., a wall next to an outdoor grill), and/or be otherwise mounted. In an example, one UIC can be disconnected from the smart grill and swapped out for another UIC device (e.g., a UIC with a different set of components), unplugged to charge the UIC, and/or otherwise connected or disconnected.

The user interface controller (UIC) is preferably a handheld connected device and removably connectable to the smart grill, but can alternatively be built into the smart grill and/or have any other suitable form factor.

Preferably, the UIC can removably connect to the grill body at a UIC connect mount (e.g., mount interface). In an embodiment, the UIC can be used with the system when connected to the grill body. In variants, the UIC can be additionally or alternatively connected to its own stand 810 (e.g., magnetically, with a cable, etc.), another smart cooking device (e.g., a smart oven, a June oven, etc.), and/or any other suitable device. In a first variant, the UIC can optionally be unplugged from the smart grill (e.g., during a cooking session) and plugged into its stand (e.g., wherein the stand is brought indoors while the grill remains outdoors) to allow the user to remotely operate the grill and/or monitor cooking progress.

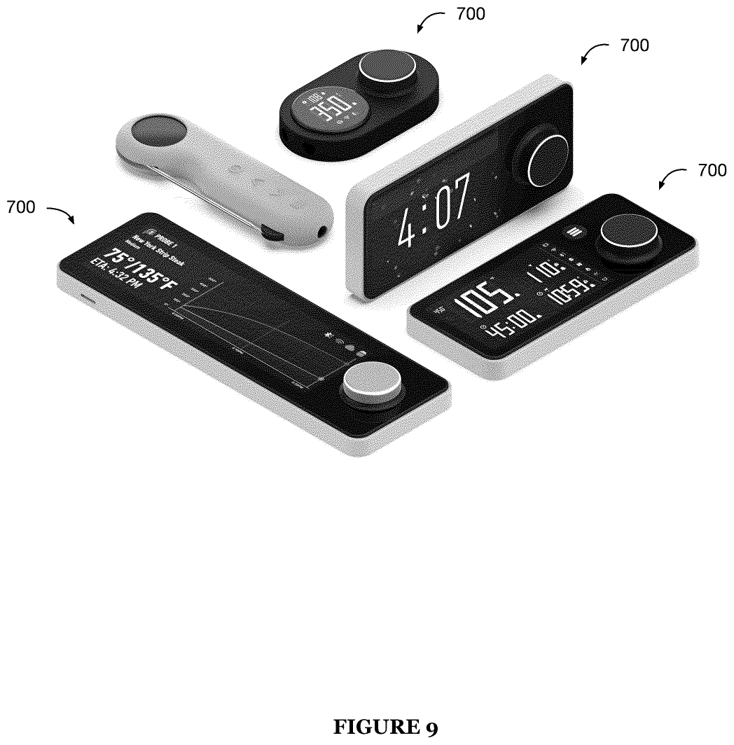

As shown in FIG. 2B, the user interface controller (UIC) 700 can include a housing 710, a display 720, a set of inputs 730, a set of sensors, a power source 740, data connections 750, a processing system, a UIC connect mount 800, and/or other components. Different models of the UIC can include different combinations of different component types (e.g., see FIG. 9).

The UIC housing 710 can function to mount and/or enclose the UIC components. The housing is preferably waterproof and/or water resistant, but can alternatively be water permeable. The housing can be thermally conductive (e.g., wherein electronic components can cool via a connection to the housing) but can alternatively be thermally insulated along one or more sides (e.g., on a grill-facing side).

The UIC display 720 functions to display information. The UIC can include one or more displays. The display can be a screen, a touchscreen, an LED display, OLED display, e-ink display, and/or any other suitable display. Displays can include: time displays, recipe information, information about a food class, grill information, sensor readings (e.g., temperature, fuel level, etc.), device information (e.g., battery level, Bluetooth connectivity success, WiFi bars, a digital power button, etc.), warnings, notifications, and/or any other display. Time displays can include: current local time, estimated cook time remaining, time until an operation (e.g., time until food item should be flipped), timers (e.g., set by the user), and/or any other information relevant to time. Recipe information can include: a recipe title, detailed information, a target food state, commands to a user, and/or any other suitable information. Grill information can include: a digital display of the grill's configuration (e.g., positions and types of heaters, probe placements, food position within the grill, etc.), identifying information about the grill (e.g., make, model, serial number, etc.), grill capabilities (e.g., a list of cooking possible cooking modalities), and/or any other suitable information. In variants, sensor readings can be displayed instantaneously, over time (e.g., on a graph), by probe (e.g., individual temperature readings for multiple probes), and/or in any other suitable format.

The UIC can include other outputs. Other outputs can include: lighting (e.g., LEDs, backlighting, etc.), speakers (e.g., to give audio instructions), haptic outputs (e.g., vibration motors), and/or any other suitable output.

The UIC can include one or more inputs 730, which function to receive user inputs. User inputs can include: recipe selection, recipe modification (e.g. target food state selection), a user feedback survey, 2-step ignition selection, user identification, food item identification, food location, grill configuration confirmation, and/or any other suitable input. UIC inputs can include: a touch screen, a physical mechanism (e.g., knob, button, dial, slider, etc.), a microphone, a sensor (e.g., touchscreen, audio input, etc.), and/or any other suitable input. The UIC input can be mounted to the UIC (e.g., the UIC housing), be remote from the UIC (e.g., on a smartphone application that connects wirelessly to the UIC), through audio (e.g., microphone), and/or otherwise located. In an example, the UIC can include a touchscreen and a knob. In a second example, the UIC can include only a knob. In a third example, the UIC can include a set of buttons. However, UIC can include any other suitable set of inputs.

The UIC can optionally include one or more sensors (e.g., temperature sensor, ambient light sensor, camera, pressure sensor, touch sensor, accelerometer, etc.). Sensors can be built into the UIC, removably connected to the UIC (e.g., via a set of connectors), and/or otherwise connected to the UIC. For example, the UIC can include a set of electrical connectors that can support connections with a set of accessories (e.g., as described under grill body). UIC sensor measurements can be processed locally (e.g., by the UIC processor), by a connected component (e.g., the processing system 500), and/or remotely. In one example, the UIC can include an ambient light sensor, a microprocessor, a set of LEDs and a touchscreen, wherein the microprocessor determines an LED brightness setting and a touchscreen brightness setting based on the light sensor measurements.

The UIC can include a power source 740 (e.g., cable charger/connector, inductive charger/connector, battery, etc.). The power source can be a connection to an external power supply. However, the power supply can additionally or alternatively be interior (e.g., a battery). In a first variant, the power source can be the cable connection to the grill body through the UIC mount. In a second variant, the power source can be a cable terminating at a plug that can connect to an outlet. The UIC can alternatively comprise multiple power sources.

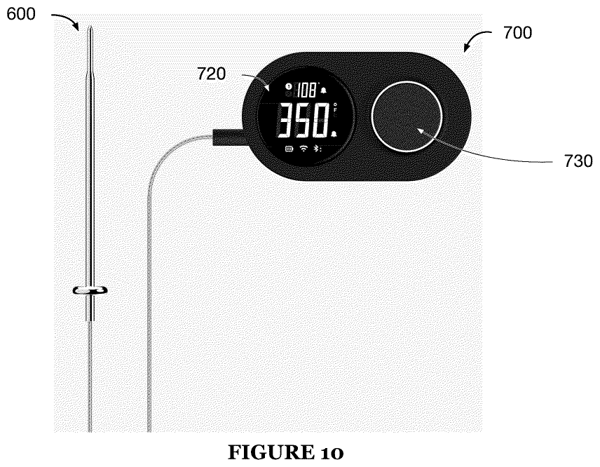

The UIC can include one or more data connections 750 that function to communicate with the control system (e.g., the grill processing system 500), the cloud platform, a user device (e.g., a smartphone application), auxiliary components, accessory modules (e.g., sensors), and/or any other suitable set of endpoints. The data connections can be the same as the power connection (e.g., USB standard connection), or be a different connection. The data connections can include wired connections, wireless connections, and/or other connections. Wired connections of the UIC can include: USB-standard connections (e.g., USB-A, USB-C, microUSB, etc.), Lightning connections, thunderport connections, and/or any other suitable set of connectors. The wired connection can be a port (e.g., female connector), male connector, and/or other connector. The wired connections are preferably located on the back of the UIC, but can additionally or alternatively be located on the left, right, top, bottom, front, and/or other side. The wired connection can optionally power or charge the UIC; alternatively, the UIC can be powered or charged by a separate power connection. Wireless connections of the UIC can include: cellular connections (e.g., LTE, 5G, 3G, etc.), Bluetooth, NFC, Zigbee, WiFi, IEEE 802—standard connections, inductive connections, and/or any other suitable set of connections. In variants, the UIC can additionally store wireless credentials (e.g., network name, password, etc.) to connect to one or more wireless networks. Credentials can be received from a user, received from the processing system, etc. In a first example, the UIC can include a wired connection on the back of the UIC (e.g., a female port, such as a USB-C port), Bluetooth (e.g., to connect to user devices, accessories, etc.), WiFi (e.g., to connect to a local area network, wherein the UIC stores the wireless credentials), and optionally a cellular connection. In a second example, the UIC can include a wired connection and Bluetooth. In a third example, the UIC can include a wired connection and WiFi. However, the UIC can include any other suitable set of data connections. In another variant, the UIC can include a set of data connections (e.g., a set of ports) to connect the UIC to a set of accessories (e.g., see FIG. 8B, see FIG. 10, etc.).

The UIC processing system can function to control the operation of the UIC, guide users through a cook program, control grill operation directly and/or indirectly (e.g., via the processing system 500), and/or perform other suitable operations. The UIC processing system can include: a CPU, GPU, TPU, IPU, microprocessor, memory, and/or any other suitable component. The UIC processing system is preferably mounted within the UIC housing, but can alternatively be mounted elsewhere.

The smart grill can be used with one or more UIC models. Different models of UICs can: take on a variety of shapes and sizes, have varying capabilities (e.g., memory, computing power, battery life, etc.), differ in their display content, differ in their input options, and/or otherwise differ. In a first example, the UIC includes a black and white display, a knob user input, wired connectivity (e.g., USB-C), Bluetooth connectivity, and optionally WiFi connectivity. In a second example, the UIC can include a touchscreen (e.g., black and white touchscreen or color touchscreen), a knob secondary user input, wired connectivity (e.g., USB-C), Bluetooth connectivity, and WiFi connectivity. In a third example, the UIC can be similar to the second example and additionally include accessory module ports (e.g., female jacks along a side of the housing). However, the UIC can be otherwise configured.

The UIC connect mount 800 of the UIC can function to couple the UIC to the grill body and/or the grill processing system 500. The UIC connect mount preferably removably couples the UIC to the grill body, but can alternatively permanently couple the UIC to the grill body. The UIC connect mount preferably connects to the complimentary connect mount, but can additionally or alternatively connect to a stand and/or to any other suitable interface or device. The UIC can include one or more UIC connect mounts. The UIC connect mount is preferably located on the back of the UIC, but can alternatively be located on the side of the UIC or along any other suitable portion of the UIC.

The UIC connect mount 800 can include: a connector 820, a shield 830 for the connector, a retention mechanism, a variety of input and output features, and/or any other suitable element.

The retention mechanism can be any form of mechanical retention (e.g., a spring, prongs with a spring feature, a clip, a magnet, a pin, etc.). The retention mechanism is preferably complimentary to the complimentary connect mount retention mechanism. The retention mechanism can further include a waterproof interface. In a first variant, the waterproof interface can be a gasket. In a second variant, the waterproof interface can be a rim or a bezel that protrudes from the back of the UIC housing, and can insert into a cavity defined by the complimentary connect mount. In an example, the waterproof interface functions as a shield 830 for the connector and entirely or partially encircle or encapsulate the connector in one or more planes. The UIC connect mount can optionally include a drainage hole.

The connector 820 (e.g., user interface connector) can be a power connection (e.g., charge the UIC; e.g., power source 740), a data connection (e.g., data connection 750), and/or any other suitable connection between the UIC and an endpoint (e.g., smart grill, stand, etc.). The connector is preferably complimentary to the complimentary connect mount's electrical connection, and/or be otherwise configured. The connectorcan be the same as the UIC electrical connection discussed above, or be a different electrical connection. The connectoris preferably centered and/or located within the interior of the retention mechanism, but can be otherwise located. The connector is preferably a female connector, but can alternatively be a male connector.

In an illustrative example, the UIC connect mount can include a protrusion (e.g., along the back of the UIC housing) that is complimentary to the complimentary connect mount's recess and a cable port 820 located within the protrusion. The protrusion can function as a shield 830 for the cable port 820.

The UIC can optionally connect to a stand 810, which can function to support the UIC when it is not attached to the grill body, provide power to the UIC, provide updates to the UIC (e.g., wired updates, wireless updates, etc.), and/or otherwise interact with the UIC. The stand can include a base, a power source, a data source, the complimentary connect mount, a shelf, accessory module connectors, and/or any other suitable component. The stand can be angled at a preset angle, adjustable, and/or otherwise configured.

### Sensors 600

The smart grill 100 can be used with and/or include a set of sensors 600. Sensors can function to collect data about food parameters (e.g., cooking state, mass, position, identity, etc.), grill state (e.g., cavity temperature, flow rate, fuel consumption rate, errors, etc.), ambient environment parameters (e.g., ambient light, temperature, humidity, pressure, etc.), and/or other parameters. The sensors can be varied, and each can affect grill operation differently.

Each sensor is preferably connected to the control system (e.g., directly), but can additionally or alternatively be connected to another component that is, in turn, connected to the control system (e.g., the UIC, a user device, etc.). Each sensor is preferably connected to the control system using a standard connector (e.g., USB connector), but can alternatively be connected to the control system using a sensor-standard connection, be soldered to the control system (e.g., to the electrical bus), and/or be otherwise connected to the control system.

In operation, the sensor data is preferably received by the processing system 500 and optionally forwarded on to another component (e.g., the UIC, the user device, cloud computing system, etc.), but can be otherwise managed. In a first variant, sensor data is directly passed to the processing system 500 over the electrical bus. In a second variant, sensor data is directly sent to the UIC (e.g., when the sensor is directly attached to the UIC, when the sensor is connected to the same electrical bus as the UIC, etc.) in a third variant, the sensor data is sent to the UIC indirectly, via the processing system 500).

Sensors can be: temperature gauges (e.g., located on the lid), tank scales, fuel sensors, ambient light sensors, temperature probes, thermocouples, remote temperature sensors, flow rate sensors, pressure sensors, level sensors, weight sensors, cameras (e.g., 2D camera, 3D camera, color camera, depth sensor, etc.), IR sensors, accelerometers, gyroscopes, humidity sensors, smoke sensors, chemical compound sensors, and/or any other type of sensors.

Sensors can be integrated into another component (e.g., UIC, grill body, lid, fuel tank, etc.), be incorporated into an accessory module, and/or otherwise configured. Sensors can additionally or alternatively be removably connected to another component (e.g., able to plug into the grill body's connectors). A smart grill unit can support any combination and quantity of sensors. Sensors may be attached (e.g., plugged in) to the electrical connectors and/or embedded into or otherwise attached to a component of the grill body.

In a first variant, the sensor can be mounted to a probe that is connected to a connector.

In a second variant, the sensor can be integrated into the grill body and/or other grill component, and optionally directly connected to the processing system 500. For example, one or more cameras can be mounted inside of the cook cavity and positioned to face a cook surface (e.g., a grate). In another example, a thermometer and/or a camera can be mounted to the grill lid. In another example, sensors can be embedded into a fuel source, a heating element, and/or any other component of and/or used with the grill.

In a third variant, the sensor can be incorporated into a connected device (e.g., an accessory module, the UIC, a smart button, etc.) that further includes a local processing system and a data connection, wherein sensor measurements can be passed to an external endpoint via its own data connection (e.g., via cable, WiFi, Bluetooth, etc.). In this variant, sensor measurements can be processed: locally (e.g., by the local processing system, by the UIC processing system, etc.), and/or remotely (e.g., by a cloud structure).

In a fourth variant, a sensor can be removably coupled to an accessory module or device. For example, sensors can plug into the sensor ports of an accessory module, wherein the accessory module, in turn, plugs into the smart grill. In variants of the UIC, sensors can plug into the sensor ports of the UIC.

In a fifth variant, the system can be used with a sensor that is remote from the system (e.g., a camera on a user's smartphone). Sensor measurements can be received by the UIC, an external endpoint (e.g., a cloud platform), a user device (e.g., through a mobile application), the processing system 500, and/or other component wirelessly and/or though a wired connection (e.g., through a cable).

In an example, the set of sensors can include a camera. The camera can be integrated into the grill body, be part of an accessory module, and/or be otherwise connected to the grill body. The camera can define a field of view. In a first variant, the camera can be mounted to the grill body with a field of view directed toward the cook cavity. In a second variant, the camera can be incorporated into the UIC. In a third variant, the camera can be remote from the system (e.g. the camera of a user's smartphone), wherein images sampled from the camera can be sent (e.g., wirelessly, through a cable, etc.) to the system (e.g., to the processing system, to the UIC, via the cloud platform, via an external platform, etc.). Images sampled by the camera can be used to: determine a food identity (e.g., a food class), determine a food item configuration within the grill cavity, troubleshoot grill operation/errors, and/or be otherwise used.

However, the sensors can be otherwise configured and used.

### Accessory Modules 900

The system is preferably used with or include a set of accessory modules 900. An accessory module can function to expand the capabilities of a grill body to which is it connected and/or used with. Expanded capabilities can include new and/or more: inputs (e.g., user inputs, sensors, etc.), outputs (e.g., user outputs, cooking abilities, etc.), and/or other capabilities. Each accessory module can have a unique functionality that enhances cook quality, cook consistency, user experience, safety, and/or any other aspect of grill operation. Examples of accessory modules can include: user inputs (e.g., buttons, touchscreens, knobs, audio inputs, etc.), user outputs (e.g., displays, speakers, etc.), cooking elements, sensors, and/or other accessory modules.

In operation, the accessory modules can communicate directly with the processing system 500 to send inputs and/or receive commands (e.g., using a standard communication protocol), but can additionally or alternatively communicate with any other endpoint (e.g., the UIC, an external server, etc.). A component of the system (e.g., the processing system 500, the UIC, a mobile application, etc.) can receive a software update to enable the system to identify, communicate with, control, and otherwise support a new type and/or model of accessory module.

The smart grill can include one or more accessory modules. The accessory modules for each smart grill can be: a default set of accessory modules, a user-selected set of accessory modules (e.g., selected when the user orders the smart grill, installed by the user, etc.), and/or otherwise determined. The accessory modules associated with each smart grill can be installed by the manufacturer, installed by the user, and/or be otherwise mounted to the smart grill. In a first variant, all grill functionalities are enabled by accessory modules. In a second variant, a subset of the grill functionalities are enabled by accessory modules, while the remaining grill functionalities are enabled by permanent inputs and/or outputs (e.g., connected to the control system by the same electrical bus as the accessory modules, or by another set of electrical connections).

Each accessory module is preferably removable from the smart grill (e.g., such that the accessory modules can be upgraded or replaced). Alternatively, the accessory module can be permanently installed into the grill body. The accessory module preferably mounted to the accessory module port of the grill body, but can alternatively be located remote from the grill body and/or otherwise arranged relative to the grill body. In an example, a accessory module can be plugged into an electrical connector of the control system through the accessory module port.

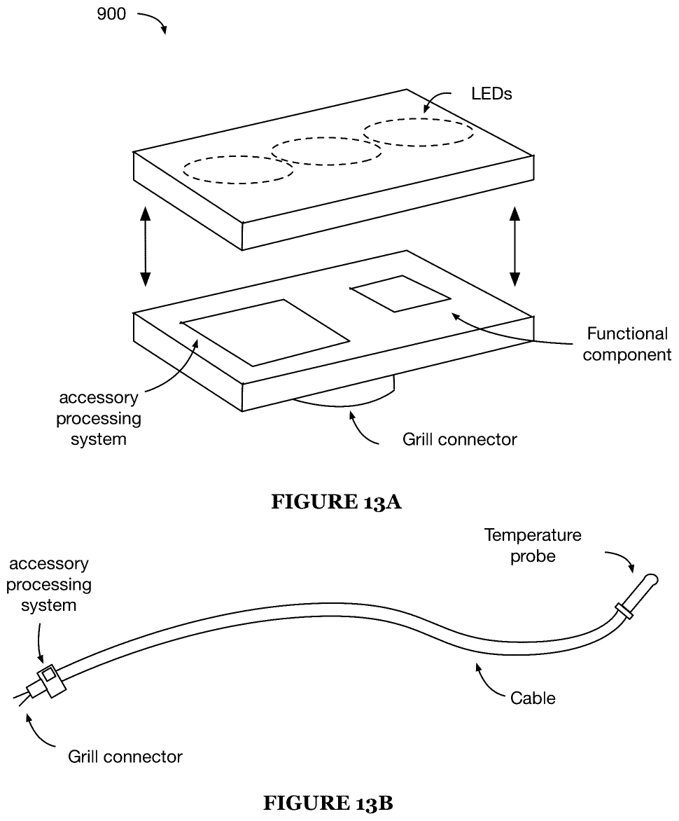

The accessory module can include: a functional component, an accessory module processing system, a connector, a housing, and/or any other suitable component (e.g., examples shown in FIG. 13A and FIG. 13B).

The functional component of the accessory module provides a functionality. Examples of functionalities can include: inputs, outputs, processing power, and/or other functionalities. In variants, the accessory modules can be classified based on the associated functionality. Examples of functional components include: sensors, user inputs (e.g., buttons, dials, knobs, sliders, touchscreens, etc.), user outputs (e.g., displays, lights, speakers, etc.), cooking elements (e.g., a gas burner, IR burner rotisserie, fans, etc.), and/or any other suitable component.

The accessory module processing system of an accessory module can function to process inputs (e.g., user inputs, sensor measurements, etc.), translate between communications protocols (e.g., between the grill protocol and the functional component's protocol), execute local decision-making (e.g., turn on a red light when a hazard is detected), and/or otherwise facilitate communication between the grill and the accessory module and/or operate the accessory module. The accessory module processing system is preferably connected to the functional component(s) and the accessory module connector, but can additionally or alternatively be connected to any other suitable components. The accessory module processing system preferably communicates with the processing system 500 using a standard grill communication protocol, but can additionally or alternatively communicate in an accessory protocol and/or alternative communication protocol. In one embodiment, all accessories can communicate with the grill using the same protocol, wherein the accessory module processing system of each accessory module handles translating between the communications protocol of the respective accessory module and the communications protocol of the processing system 500 (e.g., from the accessory module protocol to the grill protocol and/or vice versa). The accessory module processing system is preferably mounted within the accessory module housing, but can alternatively be mounted outside the accessory module housing. Alternatively, the accessory module can lack an accessory module processing system, and rely on the grill processing system 500 to interpret accessory module signals. The accessory module processing system can include: a processor (e.g., microprocessor, CPU, GPU, TPU, etc.), memory, wired and/or wireless communication chipsets, and/or other computing components.

The connector (e.g., grill connector) functions to electrically connect the accessory module to the grill. The connector preferably connects the accessory module to the grill's electrical harness or bus (e.g., through a connector on the grill body) via a complimentary connector, such that data and/or power can be passed between the accessory module the processing system 500, the UIC, another accessory module, and/or any other suitable endpoint. The connector can be a wired connection, and can allow for the transfer of data and/or power to and/or from the accessory module. The connector is preferably standard to the grill (e.g., wherein all electric accessories have the same connector), but alternatively accessories can have different connector types (e.g., different form factors, different power connectors, different data connectors, etc.). The connector can be industry-standard (e.g., USB-A, USB-C, RS485, etc.), but can alternatively be custom designed for the smart grill.

The housing can function to enclose accessory module components, to protect accessory module components (e.g., from water), to mechanically connect the accessory module to the grill body and/or another component, to serve as a mount for accessory module components (e.g., a circuit board), to facilitate a user's operation of the accessory module, and/or serve other functions. The housing can mount and/or enclose: the functional component, the accessory module processing system, the connector, and/or other components of the accessory module.

However, the accessory module can be otherwise configured.

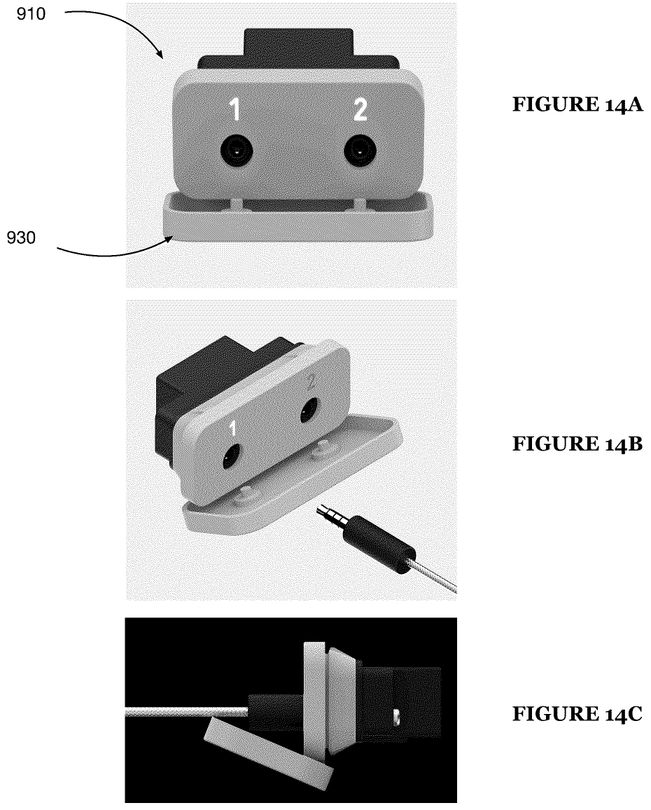

As in a first variant, the set of accessory modules includes a probe hub 910. Probe hubs can function to connect a sensor to the grill body and/or another component (e.g., the UIC); examples shown in FIGS. 14A, 14B and 14C. Probe hubs can additionally or alternatively function to increase the number of accessories that can be connected to the grill, translate between the communications protocols of the grill and another accessory module, and/or enable connection of an accessory module with a non-standard connector type to the grill. The probe hub can include a housing, a processing system (e.g., microprocessor), one or more probe connectors (e.g., female connectors, male connectors, etc.) each configured to connect to a probe, a grill connector to connect to the grill (e.g., an RS485 connector, a USB connector, etc.), and/or any other suitable component.

In a second variant, the accessory module includes a user input 920, which can function to receive user input for grill control. Inputs received from the user input can be used to: control display parameters (e.g., what information is displayed), control cooking element parameters (e.g., heat output, temperature setpoints, actuation speeds, etc.), determine recipe selections (e.g., food identity selection, target food parameter selection, etc.), receive alphanumeric data (e.g., wireless credentials), and/or obtain other data. The functional component of the user input accessory module can include: buttons, knobs, dials, sliders, touchscreen features, microphones, proximity sensors, and/or other user inputs. Inputs can be digital or analog. The user input accessory module can optionally include outputs (e.g., displays, lights, speakers, etc.). The user input accessory module can include: a housing, a grill connector, a user input (e.g., button), a processing system, and/or any other suitable element. In a specific example, the user input accessory module can be a smart button, including one or more buttons mounted within a housing, a set of backlights, a microprocessor, and a grill connector (e.g., an RS485 connector). Smart button light settings can be determined based on the measurements of an ambient light sensor (e.g., increased for higher ambient light, lowered for lower ambient light, etc.). In an illustrative example, a smart button can include two sections that display up and down arrows. In another example, the user input accessory module can include a knob, wherein twisting the knob maps to one set of outputs and pressing the knob maps to a selection.

In operation, a user input (e.g., button press) received by the user input accessory module can be dynamically mapped to different grill operation instructions based on the current recipe, a mapping selected by a user, and/or any other suitable mapping. Alternatively, the user input can be mapped to a consistent, predetermined output.

The user input mapping can be performed by the processing system 500, by the UIC (e.g., wherein the button press is sent directly to the UIC over the bus or indirectly, via the processing system 500), by a user device (e.g., wherein the button press is sent to the user device by the UIC or the processing system 500), and/or by any other suitable component. The user input is preferably dynamically mapped based on the grill operation state and/or the current recipe, but can be mapped based on a predetermined mapping or otherwise mapped.

In a first example of the second variant, the mapping is determined based on the grill operation mode. Grill operation modes can include: gas flow control, wherein an input maps to an increase/decrease in gas flow; temperature control, wherein an input maps to an increase/decrease in a temperature setpoint; rotation control, wherein an input maps to an increase/decrease in rotation speed; pellet flow control, wherein an input maps to an increase/decrease in pellet flow rate and/or auger rotation rate; airflow control, wherein an input maps to an increase/decrease in air flow rate; flame control, wherein an input maps to a change in flame height, intensity and/or profile; and any other suitable mode and outcome pairing.

In a second example of the second variant, the mapping is determined based on the control mode. Examples of control modes can include: manual control, auto-pilot control, and/or other control modes. For example, in manual mode the user may be able to directly control cooking elements via a smart button, whereas in auto-pilot control mode the user may be restricted from operating certain cooking elements and/or prompted for confirmation before altering the recipe (e.g., prompted on the UIC screen). Alternatively, no restrictions need be imposed.

In a third example of the second variant, different smart buttons can be configured to control different aspects of grill operation. For example, different smart buttons can control the heating elements, cooling elements, and lighting features. Additionally or alternatively, one smart button can be used to control multiple aspects of grill operation (e.g., 2-step ignition and grill cavity temperature). Smart buttons can be used to control individual heating elements or sets thereof (e.g., wherein one knob is turned to navigate between, select, and alter a heating element or heating zone; e.g., where each button controls a different heating element, etc.).

In a third variant, the accessory module can be a peripheral device, which can function to enhance the cooking functionality of a smart grill (e.g., allow for a new cook mode/control mode, etc.), change the user's interaction with the grill (e.g., enable audio interaction), and/or otherwise modify the capabilities of a smart grill (e.g., expand lighting options). The functional component of the peripheral device can include: fans, rotisseries (e.g., a rotisserie and a motor, etc.), lighting and/or lighting control elements, sensors, and/or any other actuator, input, output, or other functional component. The peripheral device can be specific to a grill category, or retrofit a first grill type with functionalities from another grill type. For example, a pellet grill, example peripheral devices can include any of: a pellet feeder, a motor, a fan, a glow plug, a controlled igniter, and/or other pellet grill component. For a charcoal grill, peripheral devices can include any of: a fan, a gravity feeder, a glow plug, and/or other charcoal grill component. However, the accessories can be otherwise configured.

### Control System 410

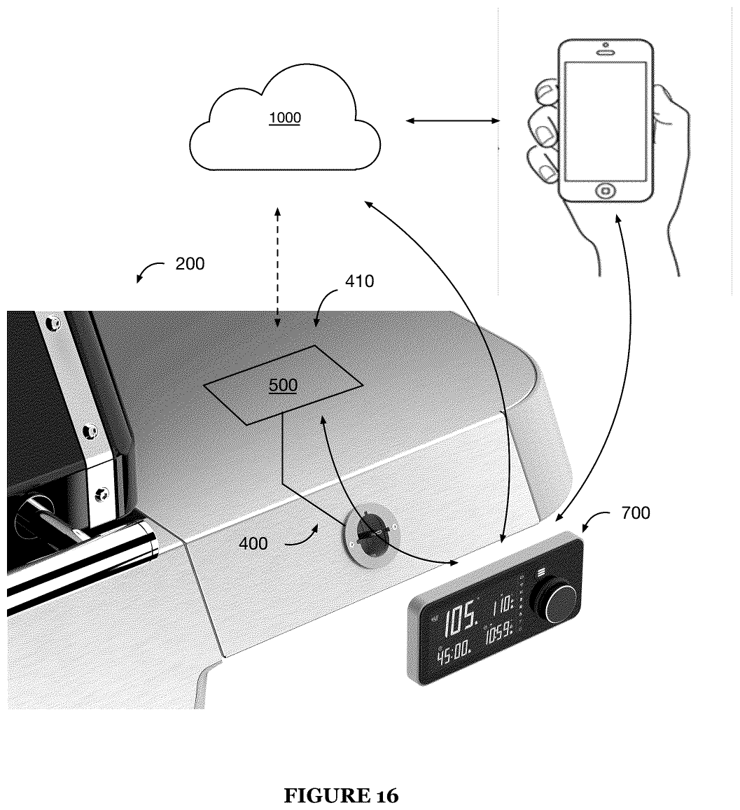

The smart grill can include a control system 410, which can function to control smart grill operation. As shown in FIG. 16, the control system can optionally interact with the cloud platform, user devices, and/or other components. The control system can optionally identify and/or authorize connected devices, power accessories, power other connected devices, and/or otherwise operate. Preferably, the user does not interact directly with the control system, but rather interreacts with user input devices, the UIC, an optional external application, and other grill elements. Alternatively, the user can interact directly with the control system.

The control system can power the grill components, receive data from the grill components, send data (e.g., instructions) to the grill components, and/or otherwise interact with the grill components. The control system preferably interacts with the grill components using a grill standard communications protocol, but can alternatively interact with the grill components using alternative protocols (e.g., an accessory module-specific protocol). The control system preferably connects to the grill components using a wired connection, but can additionally or alternatively connect to the grill components using a wireless connection. The control system can connect to the grill components using an industry-standard electrical connector (e.g., USB, RS485, etc.), a grill-standard connector, an accessory module-specific connector, be hardwired to the accessories and/or UIC, and/or be otherwise connected to the accessories and/or UIC.

The control system is preferably located within the grill body and shielded from elements (e.g., water). It can be mounted within the grill body, preferably below the heating element plane but alternatively in the plane or above the plane. Alternatively, the control system can be located on the side, bottom, middle, or top of the grill, and/or otherwise located. Components of the control system can be spread throughout the grill body. However, the control system can be otherwise mounted to the grill body.

The control system can include: an electric bus 400, a power source, a processing system 500, and/or other suitable components.

The electric bus 400 of the control system can function to supply power the grill components and/or transfer data between the grill components (e.g., between the accessories and the processing system 500 and/or the UIC). Additionally or alternatively, all or a portion of the grill components can be hardwired to the processing system 500 via a set of cables or auxiliary wires. The control system can include one or more electric busses, wherein one or more of the grill components (e.g., cooking elements, sensors, accessories, etc.) can be connected to a common bus. In one example, different electric buses can be connected to accessories in different physical parts of the grill body. In another example, accessories that fall into a common category can be routed to the same electric bus (e.g., separate bus for user input devices vs. sensors). The electrical bus can be: an electrical busbar, a parallel bus, a serial bus, a multidrop bus, a daisy-chain bus, a cabling hub, and/or have any other suitable topology. The electrical bus can have a: RS-232, RS-485, IEEE1284, Ethernet, Universal Serial Bus, CAN, and/or other bus scheme. The electrical bus can be located in a grill body volume below the heating elements, but can additionally or alternatively extend along the grill body front, sides, back, bottom, and/or other section of the grill body and/or lid. The electrical bus can be thermally isolated from the cooking elements (e.g., thermal shielding, etc.), or alternatively not isolated. The electrical bus can be mounted to the grill body (e.g., to their interior of the grill body). Cables/wires routing from the bus can extend throughout the grill body.

The electrical bus 400 can include one or more connectors (e.g., stemming off the electrical bus) for the grill components (e.g., accessory modules, UIC, cooking elements, etc.). The connectors are preferably power and data connectors, but can alternatively only be power connectors or data connectors. The connectors are preferably aligned with an opening in the grill body (e.g., accessory port, complimentary connect mount, retention mechanism opening, etc.), but can alternatively be unaligned with a grill body opening. The connectors can be connected to the electrical bus by a tape or wire, be directly connected to the electrical bus, or be otherwise connected. The electrical bus connectors are preferably all of the same type (e.g., homogeneous), but can alternatively be of varying types (e.g., heterogeneous). Examples of electrical bus connectors that can be used include RS485, Ethernet, USB, and/or any other suitable connector type. In one embodiment, a set of connectors can mount to a plurality of openings defined by the grill body. In this embodiment, smart buttons, probes, the UIC, and/or other accessories can be plugged into a portion of the connectors that is accessible from a user-facing side of the grill body.

The control system is preferably powered by a power source, but can be otherwise powered. In variants, the control system and/or grill components can be connected to the power source by the electrical bus. However, the control system and/or grill components can be otherwise connected to the power source. The power source can include: a plug (e.g., a wall plug), a battery, wireless power (e.g., RF power, induction power, etc.), and/or be otherwise powered. In one example, a backup battery can be located underneath the grill cavity and shielded from the elements, and a power cable can be located behind the grill along a bottom rim of the grill. However, the control system can be otherwise powered.

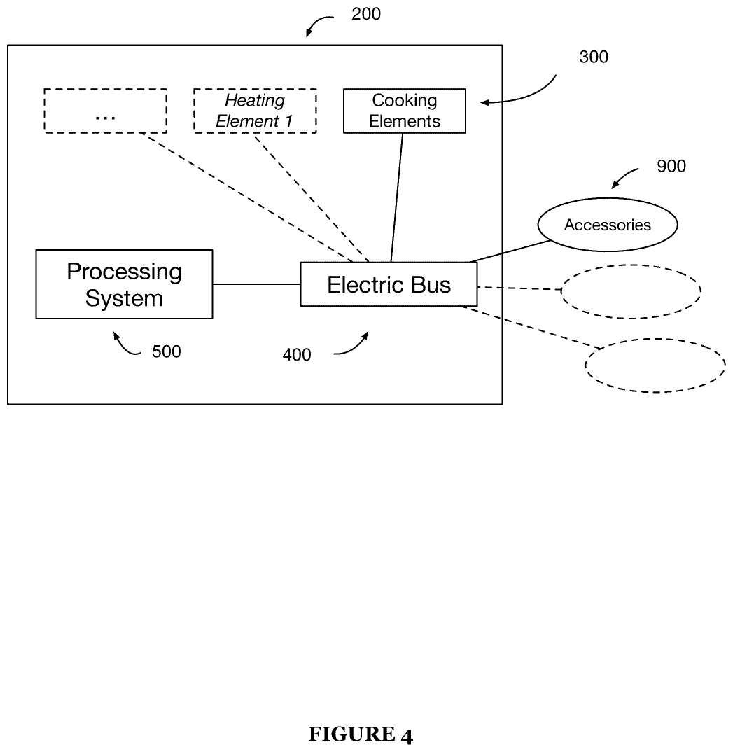

The processing system 500 of the control system functions to control grill operation. The processing system can be connected to the electric bus 400, grill component wiring, other circuitry, and/or other components (e.g., example shown in FIG. 4).

The control system can include one or more processing systems 500, each of which can be connected to the same or different electric bus 400. In a variant, the same processing system can be used for different grill configurations (e.g., different grill models, different number of burners, different sized grill, etc.). In a second variant, different processing systems can be used for and/or be compatible with different grill configurations. In an example, each processing system model can have a maximum number of temperature probes it can support, number of burners it can support, and/or any other restrictions. Some processing system models can be configured with different capabilities (e.g., zone cooking vs. no zone cooking).

The processing system 500 can include: one or more processors, memory, communications modules, and/or other computing components.

The processor can be a microprocessor, CPU, GPU, TPU, and/or other suitable processor. The memory can include RAM, DRAM, SRAM, ROM, PROM, EPROM, EEPROM, cache, external, optical drive, magnetic, solid-state, and/or other computing memory. The memory can be configured to store: one or more food class identifiers, one or more sets of cooking instructions or grill operation instructions, one or more device identifiers (e.g., grill identifier, sensor identifier, cooking element identifier, accessory module identifier, etc.), grill information (e.g., grill make, model, serial number, configuration, software version, etc.), one or more sets of credentials (e.g., accessory module authentication information, wireless credentials, login information, cryptographic keys, tokens, etc.), cooking session history, user identifiers, and/or other information. The stored information can be used to: determine system updates, determine operation instructions, authenticate newly-connected accessories and/or grill components, and/or otherwise used. In an example, the accessory module or UIC can validate the grill based on the stored authentication information (and/or vice versa) before operation. The processing system can optionally include one or more communication modules. The processing system preferably does not include any wireless communication capabilities (e.g., WiFi, Bluetooth, Zigbee, cellular, etc.), but can alternatively include wireless communication capabilities (e.g., include one or more wireless gateways). However, the processing system can include any other suitable set of components.

The processing system 500 can: receive data from grill components (e.g., sensor measurements, component states, component operation instructions, etc.); control grill component operation (e.g., determine grill component operation instructions, forward grill component operation instructions, etc.); act as an intermediary between the grill components and the UIC; authenticate connected devices; determine a configuration of the grill; facilitate inter-component communication (e.g., so that a grill component knows what other grill components are connected to the system); execute and/or verify receipt of a 2-step ignition sequence; determine food parameters (e.g., food identity, food count, food mass, food position, etc.) for food within the cook cavity (e.g., based on images or other measurements sampled by the sensors, such as by using the methods disclosed in such as that disclosed in U.S. application Ser. No. 17/014,932 filed 8 Sep. 2020, incorporated herein in its entirety by this reference); predict grill states and/or food states (e.g., determine an estimated time to cooking completion, such as that disclosed in U.S. application Ser. No. 17/014,932 filed 8 Sep. 2020 and/or U.S. application Ser. No. 17/885,396 filed 10 Aug. 2022, each of which incorporated herein in its entirety by this reference); and/or perform any other suitable function.

In variants, the processing system 500 can be operable between a set of different control modes (e.g., operation modes).

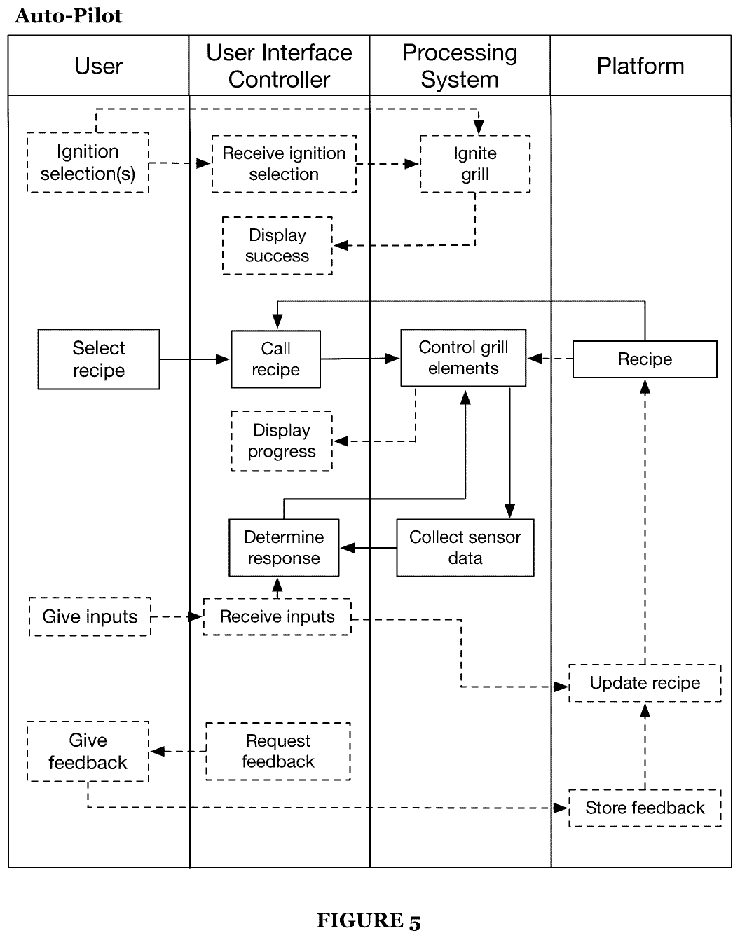

In a first control mode (e.g., auto-pilot mode; automatic cooking mode; etc.), a cook program can be determined and executed by the processing system. In a first variant, this mode can include, at the processing system: automatically determining a set of cooking instructions (e.g., based on a user selection, based on an automatically-determined food identity, etc.); controlling the cooking elements according to the cooking instructions; optionally receiving sensor measurements from the sensors; optionally receiving user inputs from the accessories, the UIC, and/or a user device; optionally determining updated cooking instructions based on the sensor measurements and/or user inputs; and optionally controlling the cooking elements according to the updated cooking instructions. In a second variant, this mode can include all the processes of the first variant, except that the processes are split between the processing system and the UIC. For example, the UIC can determine the recipe and determine the cooking instructions, wherein the UIC instructs the processing system 500 to control the grill components according to the cooking instructions (e.g., see FIG. 5). In an illustrative example, the UIC can determine the cavity temperature setpoints, wherein the processing system can determine the heating element setpoints needed to achieve the cavity temperature setpoint. In a second illustrative example, the UIC can directly determine the heating element setpoints. In this example, the UIC can additionally or alternatively receive the sensor measurements and/or user inputs (e.g., wherein the processing system 500 can forward the sensor measurements and/or user inputs to the UIC), and determine the updated cooking instructions. However, the processes can be otherwise split. However, the first mode can be otherwise executed.

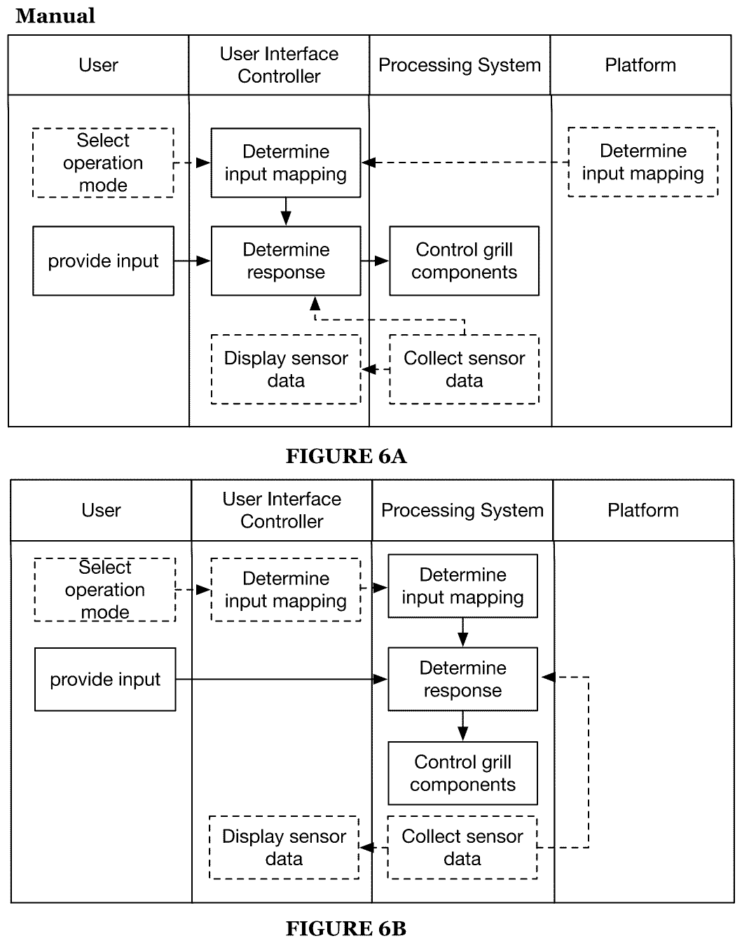

In a second control mode (e.g., manual control mode), the processing system controls grill components based on user inputs (e.g., examples shown in FIGS. 6A and 6B). The user inputs can be received from: the UIC (e.g., over a wireless connection, over the electrical bus, etc.), an accessory module (e.g., over the electrical bus), a user device (e.g., via the UIC or other gateway), a cloud platform (e.g., via the UIC or other gateway), and/or any other suitable endpoint. The set of grill components controlled by the user input is preferably predetermined (e.g., hardcoded, mapped by the user), but can alternatively be dynamically determined (e.g., based on a cook mode) and/or otherwise determined. In an example, the user input can be mapped to a heat output in a grill mode, be mapped to a subset of heating elements in a controlled zone mode, be mapped to a rotisserie rotation rate in a rotisserie mode, be mapped to an IR output in a sear mode, and/or be mapped to any other suitable output in any other suitable cooking mode.

The processing system 500 can optionally function to determine the configuration of the smart grill. For example, the processing system 500 can determine which grill components (e.g., accessory modules, cooking elements, etc.) are available (e.g., connected to the electric bus), determine where the grill components are located (e.g., based on a known physical location associated with each electric bus connector), register the grill components, validate new grill components (e.g., when newly connected), and/or perform other functionalities. The smart grill configuration can be used (e.g., by the processing system 500, UIC, etc.) to: determine accessory drivers, determine associated mappings, and/or otherwise used.

However, the processing system 500 can perform any other suitable set of functionalities.

### External Platform 1000

The smart grill can be used with and/or include an external platform 1000, which can function to identify each food class, provide recipes and/or operation instructions (e.g., for each food class, for the set of food parameter values, etc.), manage inter-grill data transfer, manage grill component operation, store user account information, store user profiles, store user preferences, store grill information (e.g., grill identifiers, configuration, cook history, etc.), store authentication information, manage a fleet of smart grills (e.g., associated with a single user account), manage grill software updates, determine higher-level smart grill analytics (e.g., number of foods cooked, trends, etc.), and/or perform any other suitable functionality.

The external platform can include a remote computing system (e.g., cloud platform), local computing system, database (e.g., database of cooking instructions, recipes, user feedback, cooking session history, etc.), a distributed computing network, and/or any other suitable computing platform external to the smart grill.

The UIC, control system, user device (e.g., smartphone application), and/or other components can directly or indirectly connect to the external platform.

For example, the external platform can directly or indirectly communicate with the control system to send cook programs, receive data (e.g., sensor data, grill states, etc.), send control instructions, send updates, and/or communicate other information. In a first variant, the external platform can communicate directly with the control system via a wired connection (e.g., LAN, power over ethernet, etc.) or a wireless connection (e.g., WIFI, cellular, etc.). In a second variant, the external platform can communicate indirectly with the control system. In a first example, the external platform can communicate with the control system via the UIC (e.g., wherein the control system communicates with the UIC over a wired connection and the UIC communicates with the external platform over a wirelessly connection). In a second example, the external platform can communicate with the control system via a smartphone application, wherein the smartphone application is wirelessly connected to the control system (e.g., over Bluetooth) and is wirelessly connected to the external system (e.g., over WiFi or a cellular connection).

In another example, the external platform can directly or indirectly with the UIC to receive data & send recipes upon request.

However, the external platform can be otherwise configured.

### 4. Method

In operation, a method of operating the smart grill can include: determining a set of cooking instructions S100; controlling grill components based on the set of cooking instructions S200; optionally receiving sensor measurements from the sensors S300; optionally receiving user inputs S400; optionally determining updated cooking instructions S500; and optionally controlling the cooking elements according to the updated cooking instructions S600. However, the smart grill can be otherwise operated. All or portions of the method can be performed by: the control system, the UIC, the external system, a user device (e.g., a smartphone application), the user, and/or by any other suitable computing system. All or portions of the method can be: iteratively performed, performed for each cooking session, and/or performed at any other suitable time.

Determining the set of cooking instructions S100 functions to determine how the grill components should be operated.

In a first variant, the set of cooking instructions is automatically determined. In this variant, the set of cooking instructions can be determined based on a food identity, wherein the set of cooking instructions (e.g., recipe, set of cooking element operation instructions, etc.) associated with the food identity can be retrieved from a recipe database (e.g., stored by the external platform, the UIC, a user device, the control system, etc.). The food identity can be: received from a user, automatically determined by the system, and/or otherwise determined. The food identity can be received from the user at the UIC (e.g., using a touchscreen selection, knob-based scroll and selection, etc.), be received from the user at a user device, received from the external system, and/or otherwise received from the user. The food identity can be automatically determined based on: an image of the food within the cook cavity (e.g., using a trained food classification model, a semantic segmentation model, an instance-based semantic segmentation model, etc.); a food identifier (e.g., a QR code, a barcode, NFC tag, etc.) on the food or a food retention mechanism (e.g., tray, grate, etc.); inferred based on previously-determined food identities and/or otherwise determined. The images and/or other measurements used to determine the food identity can be sampled by: a user device (e.g., smartphone), the UIC, a camera of the smart grill (e.g., mounted in the lid, mounted at the entryway of the cooking cavity, flexibly connected to the smart grill, etc.), and/or sampled by any other suitable component or sensor. The food identity and/or parameters can be determined by the external platform (e.g., wherein the food measurements are sent to the external platform), by the UIC (e.g., wherein the food measurements are sampled by the UIC and/or sent to the UIC by the sampling device), by the user device, by the control system (e.g., wherein the food measurements are sent to the control system via the UIC or user device), and/or by any other suitable component. The cooking instruction sets can be determined by the food identifying component and/or by another component (e.g., receiving the determined food identifier and/or parameters). For example, the external platform or user device can determine the food identifier, and the UIC or control system can determine the cooking instruction set. However, the food parameters and/or cooking instruction sets can be otherwise determined. In an illustrative example, the external platform can determine a set of food classes and/or food parameters for the food within the cook cavity, determine the cooking instruction sets for each food class and/or set of food parameters, and send the cooking instruction sets to the UIC, wherein the UIC determines the cooking state for each food (e.g., where each food is in each cooking instruction set) and instructs the control system to selectively control the cooking elements to implement the next cooking instruction in the respective cooking instruction set. However, the cooking instruction set can be otherwise automatically determined.

In a second variant, the set of cooking instructions is manually determined. In a first example, the user can actuate a set of physical grill inputs to input the set of cooking instructions (e.g., in real or near-real time with cooking). In a second example, the user can input the set of cooking instructions into a grill interface, such as the UIC or a smartphone interface. In a third example, the user can program the grill (e.g., manually determine a series of cooking element operation instructions) and upload the program to the UIC and/or the control system, wherein the UIC and/or control system can monitor the cooking progress (e.g., based on sensor data, based on user inputs, etc.) and automatically control cooking element operation according to the program. However, manual user inputs can be otherwise received.

However, the set of cooking instructions can be otherwise determined.

Controlling grill components based on the set of cooking instructions S200 functions to implement the cooking instructions and cook the food. The grill components are preferably controlled by the control system, more preferably the processing system 500, but can alternatively be controlled by the UIC, the external platform, the user device, and/or by any other suitable system. The controlled grill components are preferably the cooking elements, but can additionally or alternatively be user outputs, accessories, and/or any other suitable component.

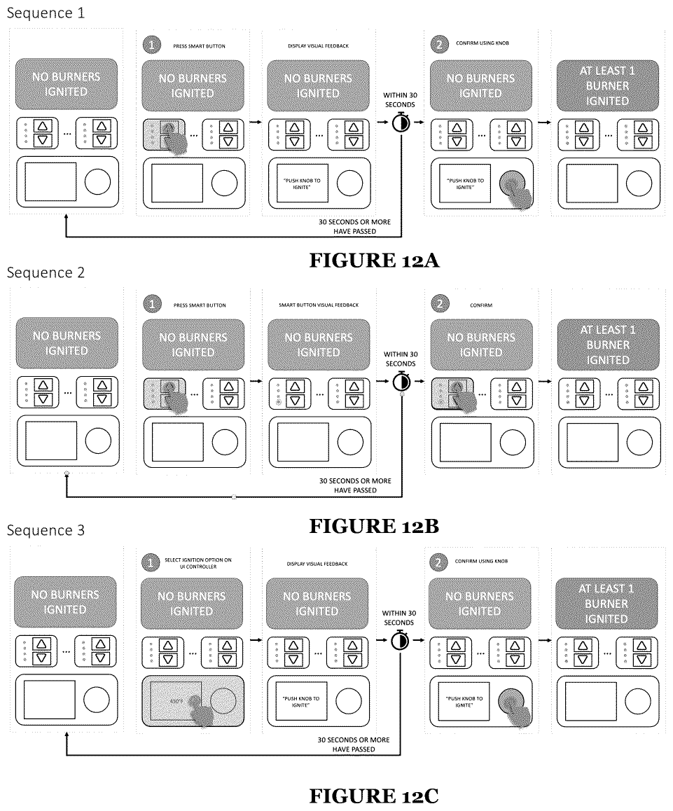

In variants, S200 can be performed after an initiation sequence is performed. The initiation sequence is preferably manually performed but can alternatively be automatically performed or otherwise performed. In an example, the initiation sequence can be an ignition sequence (e.g., examples shown in FIGS. 12A, 12B, and 12C). The ignition sequence is preferably a multi-step ignition sequence, but can alternatively be a single-step ignition sequence and/or include any other suitable number of inputs. The multi-step ignition process can include a digital input and a physical input, two digital inputs (e.g., at different interfaces), two physical inputs (e.g., at different interfaces), and/or any other suitable combination of inputs. The inputs can be received: concurrently, contemporaneously, serially (e.g., within a threshold time period), and/or at any other time. Inputs for the 2-step ignition process can include: buttons (e.g., an ignite button on the user-facing side of the grill body), knobs, user input devices (e.g., smart buttons), user interface controller inputs (e.g., on a touchscreen, on a knob, etc.), auxiliary application inputs (e.g. smartphone app selection), and/or any other suitable form of input.

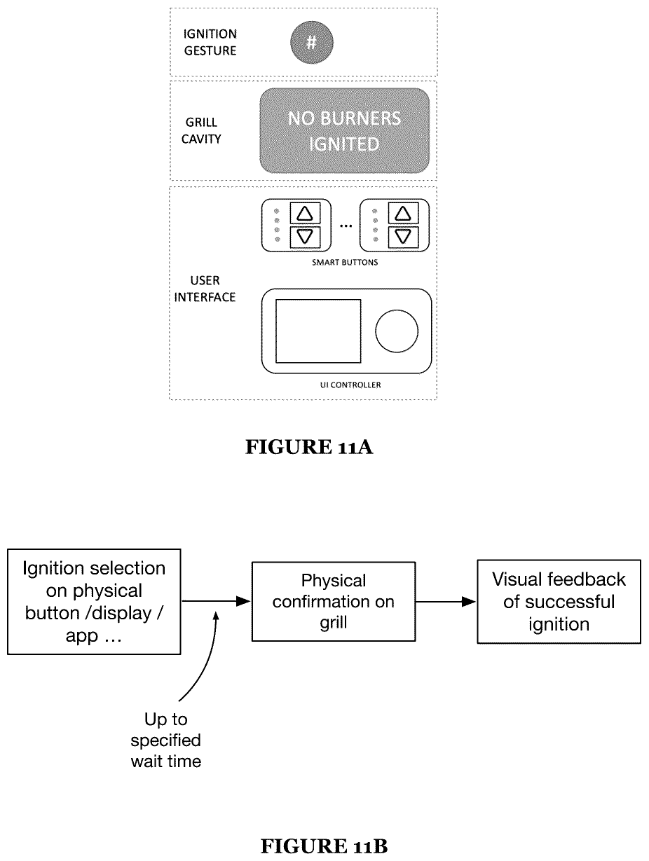

In a first example, the multi-step ignition process includes a knob turn and press. In a second example, the multi-step ignition process includes a heating element selection on a digital interface and actuation of an ignition button on the grill (e.g., example shown in FIG. 11B). The digital interface can be a connected UIC, a disconnected UIC, a smartphone application, and/or any other suitable digital interface. In a third example, the multi-step ignition process includes concurrent selection of a heating element on a digital interface and selection of a digital start button. In a fourth example, the multi-step ignition process includes actuation of a physical input associated with the heating element (e.g., heating element button) and digital or physical confirmation (e.g., via selection of a digital or physical button, see FIG. 11A, etc.).

However, the multi-step ignition process can be otherwise performed.

Optionally receiving sensor measurements from the sensors S300 functions to: monitor the state of the food and/or grill. The sensor measurements can be used to determine whether the next cooking instruction should be implemented, whether the cooking session is done, and/or otherwise used. The sensor measurements are preferably received while the food is cooking but can alternatively be received before or after. The sensor measurements are preferably received at the control system, more preferably the processing system 500, but can alternatively be received (e.g., directly or indirectly) at the UIC, the user device, the external system, and/or any other suitable system. The sensor measurements can be received from the accessories, the sensors, sensors connected to the UIC or an accessory module, and/or from any other suitable source.

Optionally receiving user inputs S400 functions to: adjust grill component operation instructions, to confirm that a prior cooking instruction (e.g., manual cooking instruction) was completed, and/or otherwise used. The user inputs can be received while the food is cooking, be received before or after. The user inputs can be received at the UIC or the user device, an accessory module (e.g., a smart button), at the control system, the external system, and/or at any other suitable interface.

Optionally determining updated cooking instructions S500 functions to modify grill operation. The updated cooking instructions are preferably determined by the UIC, but can additionally or alternatively be determined by the user device, the control system (e.g., the processing system 500), the external platform, and/or by any other suitable component. The updated cooking instructions are preferably determined based on the sensor measurements and/or user inputs, but can additionally or alternatively be determined based on a set of rules, based on the set of cooking instructions (e.g., for the food class), and/or based on any other suitable information. The component determining the cooking instructions preferably receives the sensor measurements and/or user inputs from the processing system 500, but can additionally or alternatively directly read the sensor measurements and/or user inputs off the bus, receive the sensor measurements and/or user inputs from the UIC, and/or otherwise determine the sensor measurements and/or user inputs. The updated cooking instructions can include: the next cooking instruction in a series of cooking instructions (e.g., the next cooking step), a modified cooking element operation instruction and/or grill component setpoint (e.g., fuel flow rate, heating element setpoint, cooking cavity temperature, etc.), and/or any other suitable cooking instruction.

In a first variant, determining the updated cooking instructions includes: determining whether a prior cooking instruction has been completed (e.g., whether the sensor measurement satisfies a target measurement value, whether the user input satisfies an expected input value, etc.), and determining the next cooking instruction in the set of cooking instructions (e.g., for the food class) when the prior cooking instruction has been completed.

In a second variant, determining the updated cooking instructions includes: determining that a sensor measurement is outside of a predetermined range of acceptable measurement values for the current cooking step, and determining a set of operation instructions (e.g., cooking element operation instructions) to correct the measured parameter (e.g., performing closed-loop feedback).

In a third variant, determining the updated cooking instructions includes: determining a grill component associated with a user input, and determining the operation instruction value associated with the user input. The grill component controlled by the cooking instructions can be determined by the user (e.g., based on a prior selection), predetermined, and/or otherwise determined. The operation instruction value can be determined based on a predetermined mapping for the grill component—user input pair, based on a dynamic mapping determined based on the cook mode, and/or otherwise determined.

However, the updated cooking instructions can be otherwise determined.

Controlling the cooking elements according to the updated cooking instructions S600 functions to implement the new operation instructions. S600 is preferably performed in the same manner as S200, but can additionally or alternatively be otherwise performed.

In an example of smart grill operation, the smart grill can determine a food identity, wherein the user interface controller determines the recipe for the identified food, tracks the cooking state based on sensor measurements (e.g., sent to the user interface controller by the control system), and instructs the control system to control the grill components according to the recipe, based on the cooking state. In examples, the smart grill can receive a user input, and, depending on the cooking mode and method, the control system can selectively map a smart button input from the user to a predetermined outcome (e.g., twisting a dial to modify flame height in manual grilling mode).

However, the smart grill can be otherwise controlled.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), concurrently (e.g., in parallel), or in any other suitable order by and/or using one or more instances of the systems, elements, and/or entities described herein.

As a person skilled in the art will recognize from the previous detailed description and from the figures and claims, modifications and changes can be made to the embodiments of the invention without departing from the scope of this invention defined in the following claims.

We claim:

1. A system comprising:
a grill body;
a set of cooking elements;
a user interface controller;
a mount removably coupling the user interface controller to the grill body;
an electric bus mounted within the grill body; and
a grill processing system mounted to the grill body and electrically connected to the set of cooking elements and the user interface controller via the electric bus.

2. The system of claim 1, wherein the user interface controller comprises a user interface controller processing system.

3. The system of claim 1, wherein the mount comprises a mechanical retention feature and a user interface connector comprising a power and data connection.

4. The system of claim 1, further comprising a set of accessory modules electrically connected to the grill processing system via the electric bus, wherein each accessory module of the set comprises an accessory processing system.

5. The system of claim 4, wherein each accessory module further comprises:
a functional component electrically connected to the accessory processing system;
a housing enclosing the accessory processing system and mounting the functional component; and
a standard connector mounted to the housing and electrically connected to the accessory processing system, wherein the standard connector is configured to connect the accessory module to the electric bus.

6. The system of claim 4, wherein each accessory processing system is configured to translate functional component data between an accessory protocol and a grill-standard protocol.

7. The system of claim 1, wherein the user interface controller is configured to determine a cook program and control the grill processing system to execute the cook program.

8. The system of claim 1, wherein the grill processing system is further configured to:
determine a configuration of the grill body, the set of connected cooking accessories, and the cooking elements; and
communicate the configuration to the user interface controller.

9. The system of claim 1, wherein the processor is further configured to:
receive a digital ignition selection at the user interface controller;
receive a physical button press within a predetermined timeframe after receiving the digital ignition selection; and
ignite at least a subset of the cooking elements responsive to receipt of the physical button press.

10. The system of claim 1, wherein the system further comprises at least one of: a gas grill, a pellet grill, a charcoal grill, an electric grill, a wood grill, a kettle grill, a kamado grill, a smoker.

11. The system of claim 1, wherein the user interface controller is one of a plurality of user interface controller models, wherein each model comprises a mount interface complimentary to the mount and at least one display, user input, or wireless communication module that is different from another model.

12. A cooking system, comprising:
a cooking body;
a set of cooking elements mounted within the cooking body;
an electric bus mounted within the cooking body;
a set of accessory modules removably mounted to the cooking body and removably connected to the electric bus, wherein each module comprises an accessory processor; and
a processing system mounted to the cooking body and connected to the set of cooking elements and the set of accessory modules by the electric bus.

13. The system of claim 12, further comprising a mount configured to removably couple a user interface controller to the cooking body, wherein the user interface controller comprises a wired communication module and a wireless communication module.

14. The system of claim 13, wherein the mount comprises a recess in an exterior surface of the cooking body and a cable located within the recess, wherein a surface of the user interface controller comprises a protrusion complimentary to the recess and a cable port electrically connected to the wired communication module and located within the protrusion.

15. The system of claim 13, further comprising a cloud platform, wherein the wireless communication module of the user interface controller is configured to wirelessly connect to the cloud platform, wherein the user interface controller is configured to:
receive a set of cook programs from the cloud platform;
generate operation instructions based on data from the set of accessory modules and the set of cook programs; and
instruct the processing system to control the set of cooking elements based on the operation instructions.

16. The system of claim 15, wherein a cook program of the set of cook programs is for a food class for food cooked within the cooking body, wherein the food class is automatically determined based on an image of the food.

17. The system of claim 16, wherein the image is sampled by a smartphone application.

18. The system of claim 12, wherein the processing system is further configured to:
receive a digital ignition selection at a user interface;
receive a physical button press within a predetermined timeframe after receiving the digital ignition selection; and
ignite a subset of the heating elements responsive to the receipt of the physical button press.

19. The system of claim 18, wherein the physical button is located on a user-facing side of the grill body.

20. The system of claim 13, wherein the set of accessory modules comprises a user input device, wherein the processing system is configured to interpret a user input received at the user input device based on a cook mode determined by the user interface controller.
